(19) United States
(12) Patent Application Publication
(10) Pub. No.: US 2026/0105466 A1
(43) Pub. Date: Apr. 16, 2026

(54) AUTOMATED ZONING AND BUILDING CODE COMPLIANCE

(71) Applicant: X DEVELOPMENT LLC, Mountain View, CA (US)

(72) Inventors: Julia Black LING, Mountain View, CA (US); Jeet Hemant SHAH, Mountain View, CA (US); Prithivi AMUTHAN, Mountain View, CA (US); Divya CHOUDHARY, Mountain View, CA (US); Aaron Bennett APPELLE, Mountain View, CA (US); Adrian James WALKER, Mountain View, CA (US); Tal YARKONI, Mountain View, CA (US); David PASSEY, Mountain View, CA (US)

(21) Appl. No.: 19/418,506

(22) Filed: Dec. 12, 2025

Related U.S. Application Data
(63) Continuation of application No. PCT/US2025/032292, filed on Jun. 4, 2025.
(60) Provisional application No. 63/676,099, filed on Jul. 26, 2024.

(51) Int. Cl. G06Q 30/018; G06N 20/00

(52) U.S. Cl. CPC G06Q 30/018; G06N 20/00

(57) ABSTRACT

Methods, systems, and apparatus, including computer programs encoded on computer-storage media, for generation of computer-executable code for automated zoning compliance. Zoning, building, planning, and other regulations for a jurisdiction are provided to a trained artificial intelligence model which provides computer-executable code that is configured, when executed, to provide output that indicates whether an input candidate building plan complies with the regulations for the jurisdiction. The computer-executable code generated by the trained artificial intelligence model is deployed in an application. The application receives, in a request, a candidate building plan. The application generates and provides a compliance report for the candidate building plan that includes compliance results for the candidate building plan with respect to the regulations for the jurisdiction.

### CROSS-REFERENCE TO RELATED APPLICATION

This application claims the benefit of U.S. Provisional Application 63/676,099 filed Jul. 26, 2024, the disclosure of which is incorporated herein by reference in its entirety.

### FIELD

This specification generally relates to artificial intelligence in building construction.

### BACKGROUND

Building construction can involve numerous phases. For instance, a construction project can involve phases such as requirements gathering, site selection, design, and construction.

### SUMMARY

When architects, structural engineers and builders set about to design and create a building, completed work may be applicable to regulations set out in building, planning, and zoning code. For example, zoning laws can set bounds on permitted usage and a maximum developable envelope (e.g., where a building can exist on a site). Zoning laws may also include, for example, restrictions related to vegetation, parking, walkways and historical sites. Building code can include regulations for other project details, such as regulations related to fire safety, electrical and plumbing standards, etc. Planning code may include community standards and goals.

The task of creating compliant building designs can be challenging and can require a high degree of familiarity with laws that are often complex, overlapping, conflicting, and sometimes include multi-step logic aspects. For example, zoning and building codes may often be written in a convoluted style and can vary from region to region. Furthermore, there may often be hundreds of rules applicable to a new development or renovation, and checking whether a proposed development plan is in compliance can be a lengthy and iterative process, slowing down development and increasing costs. Further, some special cases require additional approvals or permits, which can also incur costs and/or delays. In summary, for new building developments, checking compliance with zoning codes, building codes, and other regulatory, permitting, entitlement, and compliance sources can be an onerous task.

To solve these and other problems related to zoning and building code compliance, various automated solutions can be provided. For instance, an AI (Artificial Intelligence) system can be trained to generate computer-executable code that can be executed to check compliance for a building project. For instance, the AI system can be trained to translate legalese and other types of language in zoning and building code into computer-executable code (e.g., Python or other code). The computer-executable code can be executed for a given building project (e.g., using plans for a new building project) and can provide output indicating whether or how much the building project is compliant (or non-compliant), and can also output specific outputs such as required setbacks, a maximum buildable volume, and what additional permits or approvals may be required. As another example, in some implementations, an AI system can be trained to answer compliance-related queries related to a corpus of zoning, planning, and building code data.

One innovative aspect of the subject matter described in this specification is embodied in a method that includes: identifying zoning, planning, and building regulations relevant for building development for a jurisdiction; providing the zoning, planning, and building regulations to a trained artificial intelligence model that is trained to generate computer-executable code based on zoning, planning, and building regulation data; receiving, from the trained artificial intelligence model, first computer-executable code that is configured, when executed, to provide output that indicates whether an input candidate building plan complies with the zoning, planning, and building regulations for the jurisdiction; deploying the first computer-executable code generated by the trained artificial intelligence model in a first application; providing, in a first request, a first candidate building plan to the first application that includes the first computer-executable code; receiving, from the first application that includes the first computer-executable code, a compliance report for the first candidate building plan that includes compliance results for the first candidate building plan with respect to the zoning, planning, and building regulations for the jurisdiction; and providing the compliance report in response to the first request.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation causes the system to perform the actions. One or more computer programs can be so configured by virtue of having instructions that, when executed by data processing apparatus, cause the apparatus to perform the actions.

The foregoing and other embodiments can each optionally include one or more of the following features, alone or in combination. Enriched zoning, planning, and building regulations can be created by enriching the zoning, planning, and building regulations with additional data. The enriched zoning, planning, and building regulations can be provided to the trained artificial intelligence model. Enriching can include translating table cell content for a first cell included in the zoning, planning, and building regulations into a sentence form that includes column and row header information corresponding to the first cell. Enriching can include replacing a first content reference in the zoning, planning, and building regulations with regulation content referenced by the first content reference. The trained artificial intelligence model can generate the first executable code by performing multiple translation steps. Output from a first translation step can include intermediate computer-executable code. The intermediate computer-executable code can be provided as input to a second translation step that includes adjusting the intermediate computer-executable code. Adjusting the intermediate computer-executable code can include adding logging code, adding error-handling code, or adjusting portions of the intermediate computer-executable code. The first executable code can be validated by providing the first executable code to a set of one or more AI-based or rule-based scoring functions that score the compliance checking code for executability, performance, correct syntax, and consistency with original regulatory text. The compliance report can indicate, for the first candidate building plan, with which regulations the first candidate building plan is in compliance, with which regulations the first candidate building plan is not in compliance, and with which regulations the first candidate building plan might not be in compliance. Providing the first candidate building plan to the trained artificial intelligence model can include: generating a vector representation of the first candidate building plan; and providing the vector representation of the first candidate building plan to the trained artificial intelligence model. The compliance report can indicate how and which specific conditions in the first candidate building plan were met that led to a given regulation applying to a particular portion of the first candidate building plan. The specific conditions can be presented in a graphical tree representation. Geospatial analysis can be performed for the first candidate building plan. A determination can be made that certain conditions in the zoning, planning, and building regulations are met based on the geospatial analysis. A determination can be made regarding with which zoning, planning, or building regulations the first candidate building plan is in compliance based on determining that the certain conditions are met. Providing the compliance report can include providing information from the compliance report to a trained artificial intelligence design system trained to generate building designs for a building project. The information from the compliance report can include constraints on specifications for the building project determined from the zoning, planning, and building regulations that are used by the trained artificial intelligence design system to generate building designs that comply with the constraints on the specifications for the building project.

The details of one or more implementations are set forth in the accompanying drawings and the description, below. Other potential features and advantages of the disclosure will be apparent from the description and drawings, and from the claims.

### BRIEF DESCRIPTION OF THE DRAWINGS

FIG. 1A illustrates an example system for AI generation of computer-executable code for automated zoning compliance.

FIG. 1B illustrates an example system for automated zoning compliance.

FIG. 2 illustrates an example compliance system for automated zoning compliance checking.

FIG. 3 illustrates an example user interface for reporting building and zoning compliance results.

FIG. 4A is a flowchart of an example method for automatically generating computer-executable code for checking zoning and building code compliance.

FIG. 4B is a flowchart of an example method for training a code-generation artificial intelligence system to generate computer-executable code for checking zoning and building code compliance.

FIG. 5 illustrates an example user interface of an interactive building compliance tool.

FIG. 6 illustrates a system for extracting and augmenting structured zoning and building code information.

FIG. 7 illustrates an example question and answering system for zoning and building code compliance.

FIG. 8 illustrates an example system for compliance assessment.

FIG. 9 is a flowchart of an example method for automated zoning compliance.

### DETAILED DESCRIPTION

This disclosure generally relates to automated zoning and building code compliance, and other types of compliance. Mention of some of zoning, planning, or building code compliance below can be applied to all of zoning, planning, building, and other types of regulatory compliance.

### AI Generation of Computer-Executable Code for Automated Zoning Compliance

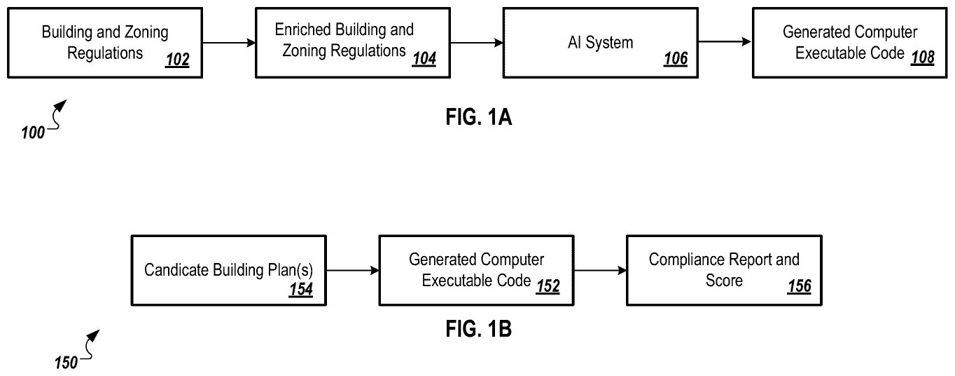

FIG. 1A illustrates an example system 100 for AI generation of computer-executable code for automated zoning compliance. Building and zoning regulations 102 can be enriched, by an enrichment system, to generate enriched building and zoning regulations 104. The building and zoning regulations 102 can include building and zoning regulations pertinent to building developments as well as any other legal or entitlement documents pertaining to building developments. The building and zoning regulations 102 may be divided into chapters, sections, and subsections. As mentioned above, zoning regulations can set bounds on permitted usage and a maximum developable envelope and building codes can include regulations for other project details, such as regulations related to fire safety, electrical and plumbing standards, etc. Planning regulations may also be identified and enriched.

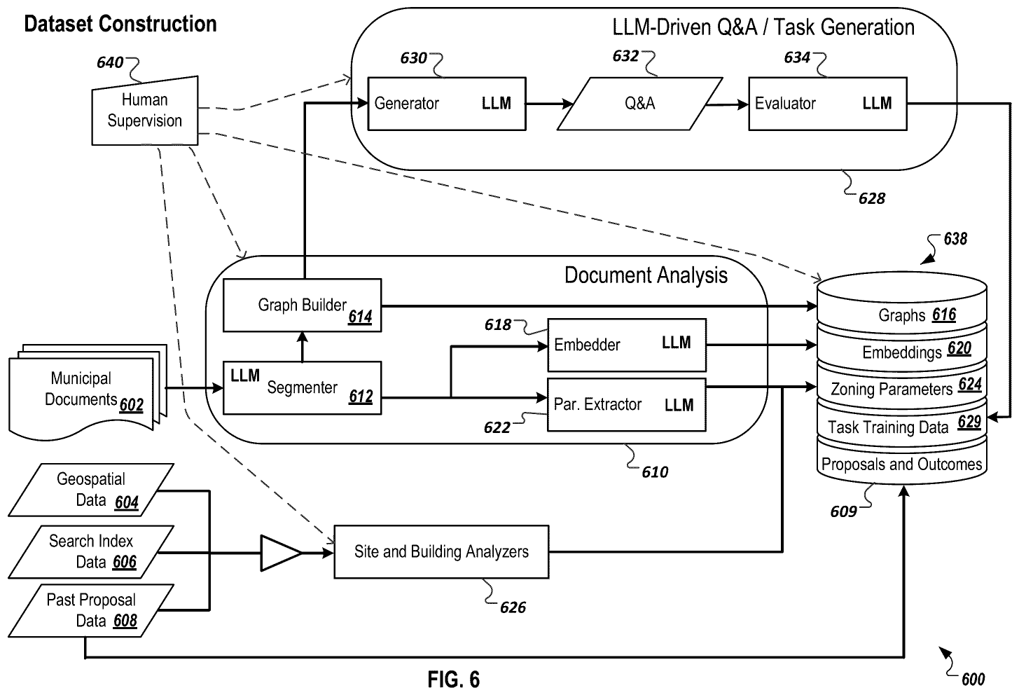

The building and zoning regulations 102 may be enriched programmatically by a data enricher engine to include, for example, references and definitions and to include translations from tables or figures to plain text or scripting formats. For example, if a given section of zoning code references a different section of zoning code or a term defined elsewhere, the text of the zoning code section may be enriched by the data enricher including the pertinent referenced sections and definitions into section text. In some examples, if the code includes a table, the code can be enriched by the data enricher creating a separate sentence for each entry in the table with pertinent header and row information as well as any footnote information. Data enrichment by the data enricher can result in text sections being complete as stand-alone sections instead of dependent on internal or external references. In some cases, other text translations of tables and/or text translations of figures can be included in the enriched building and zoning regulations 104. Further examples are described below with respect to FIG. 6. In other cases, the data may be enriched by other data sources such as permitting records, records of previous permits and variances granted, or city council meeting notes and recordings indicating outcomes of previous developments. For example, if the zoning code indicates that a given case requires a special permit, the zoning code data may be enriched by additional data that indicates how long those special permits have taken in the past to be granted, and what fraction of them have been granted over time.

The enriched building and zoning regulations 104 can be provided to an AI system 106 that is trained to generate computer-executable code capable of checking a building plan for building and zoning compliance. The AI system 106 can be or include an AI model (e.g., a transformer). The AI system 106 can generate computer-executable code 108 based on the enriched building and zoning regulations 104. The computer-executable code 108 can be used in an application phase, as described below with respect to FIG. 1B. As used herein “computer-executable code” can include code generated by the AI system 106 that is then compiled by a compiler into machine-executable code. For instance, the AI system 106 can generate C++ code that is then compiled. Alternatively or additionally, “computer-executable code” can include code generated by the AI system 106 that is interpreted, at runtime, by an interpreter. For example, the AI system 106 can generate Python code that is later interpreted at runtime leading to machine execution of interpreted code. Other approaches can be used, such as generating code that runs on a virtual machine.

In further detail regarding computer-executable code generation, the AI system 106 can be used, for example, to translate building and zoning code and other regulations from new jurisdictions into executable computer code. For example, the building and zoning regulations 102 can include zoning code for a city that states that building setbacks in a given district must be at least 15 feet in the front, 20 feet in the rear, and 5 feet on each side. The AI system 106 can translate this regulation into an executable program (or a portion of a program) that, when executed, can check a given planned development to determine whether the setbacks in the plan development obey the regulation.

The AI system 106 may complete the translation of the enriched building and zoning regulations 104 into the computer-executable code 108 in one step or in several steps which are not necessarily sequential. For instance, some translation steps might be executed simultaneously and/or independently of each other and the output of these steps may be combined for the input to subsequent steps. The output of a given translation step may be computer executable code, plain text, structured text, or some combination of these. For example, a first step can involve translation of regulations into computer executable code for performing regulation checks and a second step can involve modifying computer executable code from the first step with detailed logging, error reduction or capture modifications, improved embedded documentation (e.g., “docstrings), and/or improved structure, etc.

The AI system 106 can be trained on a corpus of training data that can include regulation data and labels referencing associated computer executable code. In some cases, the training corpus may be manually (e.g., expert) curated. For instance, a software engineer may create computer-executable code for given zoning or building code sections. In some cases, the training corpus may be augmented with synthetically generated examples, for example via AI-generated rewordings or variations. In some implementations, training the AI system 106 can include providing the AI system 106 with some examples of translations of regulations into computer-executable code and prompting the AI system to translate a new section of regulation (e.g., a few-shot prompting approach). In some implementations, training the AI system 106 can include providing a prompt to the AI system 106 that asks the AI system 106 to translate a new section of regulation into computer-executable code (e.g., a zero shot prompting approach).

In some examples, the AI system 106 may be given a chain of thought and asked to provide reasoning for its responses. For example, it may be told to generate code along with reasoning, either in comments or separately in text, for how the generated code addresses the constraints laid out in the regulations.

Once trained, the AI system 106 can be validated. For example, accuracy of the AI system 106 in generating computer-executable code that corresponds directly to corresponding zoning and building regulations can be evaluated. For instance, a large set of building development plans can be generated synthetically or compiled. These building development plans can be assessed programmatically for compliance using the AI-generated computer-executable code 108 as well as using expert-curated computer code in the training data. For example, results of executing these two types of computer code can be compared to determine whether the AI-generated computer-executable code 108 is functionally equivalent to the expert-curated computer code. In some examples, the AI system 106 or another AI model may be provided AI-generated executable code and original text (e.g., the enriched building and zoning regulations 104) and be asked to check for consistency.

The AI generated code may also be validated using other scoring approaches. For example, it may be fed into an AI validation module that checks for executability, for syntax, for the correctness of API calls, for the correctness of any values, for the correctness of condition checks, or other correctness or performance metrics. For example, the generated code and the original regulatory text may be fed to an AI model that has been trained or prompted to score the code based on whether all the numbers in the generated code match values in the original text.

Validated and AI-generated computer-executable code that, when executed, can automatically check a building plan for compliance can provide various advantages over other approaches, including an AI trained question and answer system described below. For instance, the AI-generated computer-executable code can be a verifiable, static artifact for a set of building and zoning regulations. The static artifact, once validated, can be deployed with confidence of generating predictable and accurate results. While AI trained question and answer systems can provide certain advantages, those systems may not always return exact same results, as a model may learn and change over time. Furthermore, a deployed computer-executable code artifact can return results in a manner of milliseconds, whereas prompting, in real time, a trained AI system such as an LLM may result in a lesser, less predictable, and possibly unacceptable performance in some cases.

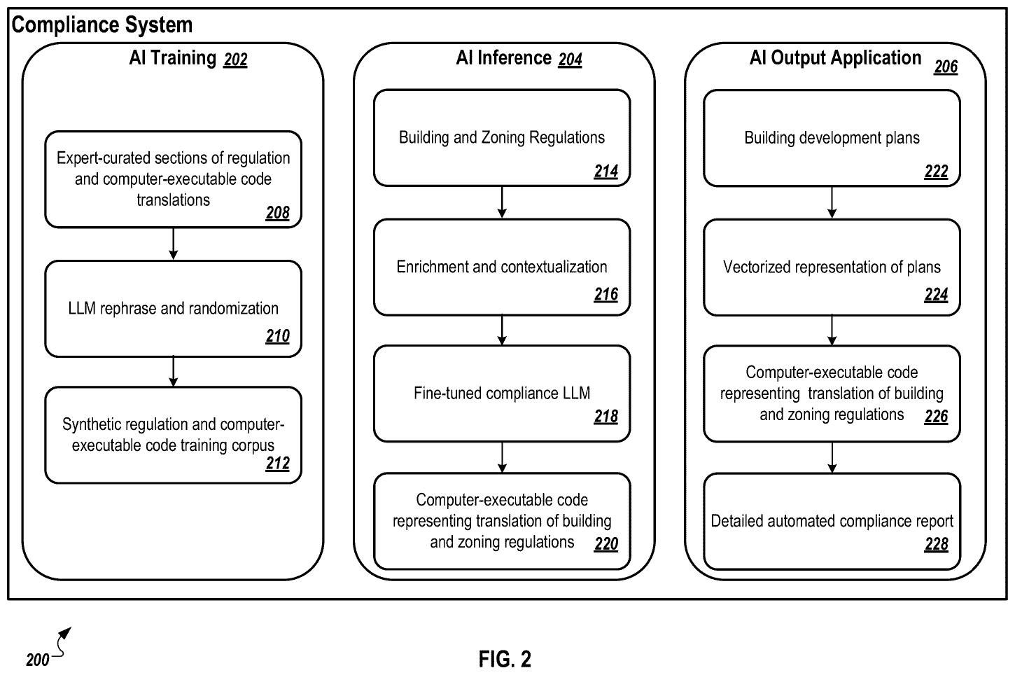

FIG. 1B illustrates an example system 150 for automated zoning compliance. Computer-executable code 152 that has been generated, for example, by the AI system 106 of FIG. 1A, can receive as input one or more candidate building plan(s) 154. The computer-executable code 152 can process the candidate building plan(s) 154. The computer-executable code 152 can receive vectorized versions of the candidate building plans 154, as described below. Processing of the candidate building plan(s) 154 by the computer-executable code 152 can result in generation by the computer-executable code 152 of a compliance report and score 156 that indicates whether the candidate plan(s) are in compliance with building and zoning regulations (e.g., the enriched building and zoning regulations 104) for which the computer-executable code 152 was generated. Compliance reports are described in more detail below with respect to FIG. 2.

FIG. 2 illustrates an example compliance system 200 for automated zoning compliance checking. The compliance system 200 includes an AI training portion 202 for training an AI system to generate computer-executable code that can check building and zoning compliance of building plans. Once trained, the AI system can be used, in an inference portion 204 of the compliance system 200, to generate computer-executable code for checking a set of building and zoning regulations. The generated computer-executable code can be used in an AI output application portion 206 of the compliance system 200 to check particular building plan(s).

In further detail, in the AI training portion 202, expert-curated sections of regulations and computer-executable code translations 208 of those regulations can be generated and/or identified.

The expert-curated sections of regulations and computer-executable code translations 208 can be provided as training data to the AI system. The AI system, which can be a large language model, can be prompted to perform rephrasing and randomization to expand the training data. In some examples, a corpus 210 of training data that includes synthetic regulations and corresponding computer-executable code translations of those regulations can be provided for training the AI system.

In the inference portion 204, a set of building and zoning regulations 214 (and in some cases planning regulations) can be provided to the trained AI system. The set of building and zoning regulations 214 can be enriched by an enrichment and contextualization engine 216. The enriched building and zoning regulations can be provided to the AI system (e.g., shown here as a fine-tuned compliance LLM 218, where the AI system can be considered to be fine-tuned after the AI training portion 202). The fine-tuned AI system can generate computer-executable code 220 that represents a computer-executable translation of the building and zoning regulations 214.

The computer-executable code 220 can be used in the AI output application portion 206 of the compliance system 200. For example, building development plans 222 for which a compliance check is desired can be identified. A deployed version 226 of the computer-executable code 220 can be used to assess a single building plan or a set of building plans, for example. The deployed version 226 of the computer-executable code 220 can be applied to a single site or to compare the viability of building plans across multiple sites.

A vectorizer can generate a vectorized representation 224 of the building development plans 222. The deployed version 226 of the computer-executable code 220 can receive the vectorized representation 224 as input and can generate a detailed automated compliance report 228 that indicates which of the building development plans 222 are in compliance with the building and zoning regulations 214, which plans are non-compliant, which portions of the plans violate which rules specified in the regulations, etc. In some cases, the detailed automated compliance report 228 includes a score for a plan which indicates an overall level of compliance. In some cases, compliance scores can be provided for each regulation relevant to a given plan.

In further detail, the detailed automated compliance report 228 can specify with which sections of code the building development plans 222 are in compliance, possibly in compliance, and out of compliance. The detailed automated compliance report 228 can be in various formats, such as PDF, HTML, plain text, or in the form of a detailed decision tree showing how each requirement was met or not met, depending on any special criteria relevant to a particular parcel. For example, the detailed automated compliance report 228, rather than simply reporting that a building in the building development plans 222 is too tall, can enable the user to navigate through or view a decision tree that can indicate, for example, that the building (which may, for example, have a planned three stories) is too tall because the building is proposed for a particular zoning district, would be next to an arterial street, and a planned front setback is only 10 ft, all resulting in a limitation of only being able to build to a maximum of two stories. Other than or in addition to a decision tree, the report may include other compliance traces indicating which specific conditions were met that led to a given regulation applying to a given parcel or building plan.

In some implementations, the detailed automated compliance report 228 can include importance levels that may have been considered (e.g., as weights) by the compliance system 200. For example, the compliance system 200 may weight different regulations differently depending on regulation importance (e.g., where regulation importance can correspond to a likelihood of obtaining an exception for a regulation violation, with more important regulations having a lower exception likelihood than less important regulations). For example, the compliance system 200 may have access to a database with information about which exceptions have been more likely to be granted historically. In some examples, the user may be allowed (e.g., using an application that includes the computer-executable code 226) to indicate that they are willing to seek exceptions to some regulations but not others.

In some implementations, information in the detailed automated compliance report 228 can be fed back into the fine-tuned compliance LLM 218. In some implementations, information from the detailed automated compliance report 228 (and/or other output from the compliance system 200) can be used for a design feedback process for creating new building plans that are compliant. For example, information can be provided to a design system as a set of constraints that designs should be adjusted to meet. For example, the compliance system 200 may output a maximum buildable volume (e.g., a zoning envelope), or a set of requirements for landscaping or parking, or other building constraints, to a design system for generating building plans that conform to these regulatory constraints.

In some implementations, the compliance system 200 includes and/or uses a geospatial analysis component that may be used with or by the computer-executable code 226. For instance, the computer-executable code 226 can be configured to generate a list of special conditions that are called out in the building and zoning regulations 214. Special conditions can be conditions of building plans that can be answerable for a given building plan and that may affect regulation evaluation for the building plan. For example, the special conditions can be phrased as questions and can include questions such as, “is the building on a corner?,” “does the building border an alley?”, “is the building within 100 feet of a school?”, etc. The compliance system 200 can use the geospatial analysis component to determine which special conditions may apply for the building development plans 222 and therefore which regulations may apply that are based on such conditions.

The geospatial analysis component can determine, for example, which zoning district a given parcel is in. The geospatial analysis component can check surrounding infrastructure (e.g., roads, alleys, freeways, power, water) as well as land conditions (e.g., soil type, slope). Based on answers for the building development plans 222 for identified special conditions, the compliance system 200 can automatically determine whether certain conditions represented in the computer-executable code 226 are met, and as a result, whether corresponding regulations apply to parcels of the building development plans 222. In some cases, automated geospatial analysis may be adjusted or supplemented based on geospatial analysis input provided by the user (e.g., the user may provide an answer and/or confirm whether a building is on a corner or near an alley).

In some implementations, the computer-executable code 226 can be configured to generate a set of design choices that are called out or reflected in the building and zoning regulations 214. Design choices can be whether the building development plans 222 include underground parking, whether the site includes bike racks, etc. The application that includes the computer-executable code 226 can interact with the user by querying whether the user wants to include or adjust certain design choices in the building development plans 222. For example, if a parking type is not specified in the building development plans 222, the application can prompt the user to specify whether underground or above ground parking is desired. As another example, if execution of the computer-executable code 226 identifies that a certain setting for a certain design choice affects a certain regulation and that the building development plans 222 currently do not include that setting, the application can inform the user and ask the user whether the user wishes to adjust the building development plan. For example, the application can inform the user that the building development plans 222 currently specify above ground parking but that if the plans were adjusted to include underground parking, certain regulations may then apply, not apply, or be adjusted. For example, adding underground parking may enable different-sized building(s) for the building development plans 222. After design choices have been finalized in the building development plans 222, the computer-executable code 226 can be executed, resulting in generation of the detailed automated compliance report 228.

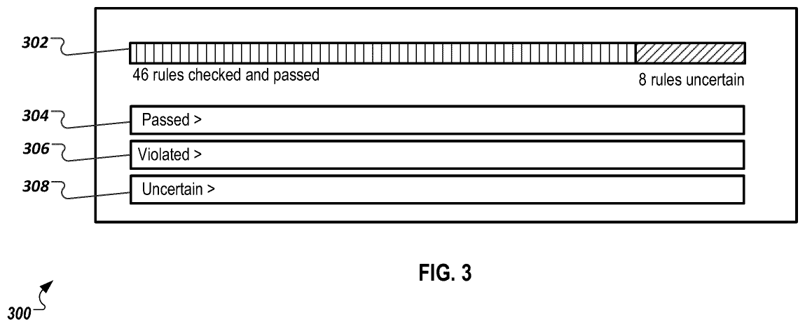

FIG. 3 illustrates an example user interface 300 for reporting building and zoning compliance results. The user interface 300 can be displayed after a user requests a compliance check for a candidate building plan, for example. The candidate building plan can be provided to AI-generated computer-executable code that has been generated by an AI engine to check compliance of an input candidate building plan against a set of building and zoning regulations. A status bar 302 provides a visualization of a split between compliance result types generated by the computer-executable code for rules in the set of rules. For instance, the status bar 302 indicates that forty eight rules have passed a compliance check for the candidate building plan and that eight rules have an uncertain compliance result (and may therefore need further evaluation, by an auditor or another system). Compliance result types can be that a rule has passed, is violated, or the result is uncertain from processing by the computer-executable code. A user can see compliance check details for rules that have compliance check results of passed, violated, or uncertain by selecting a user interface control 304, 306, or 308, respectively.

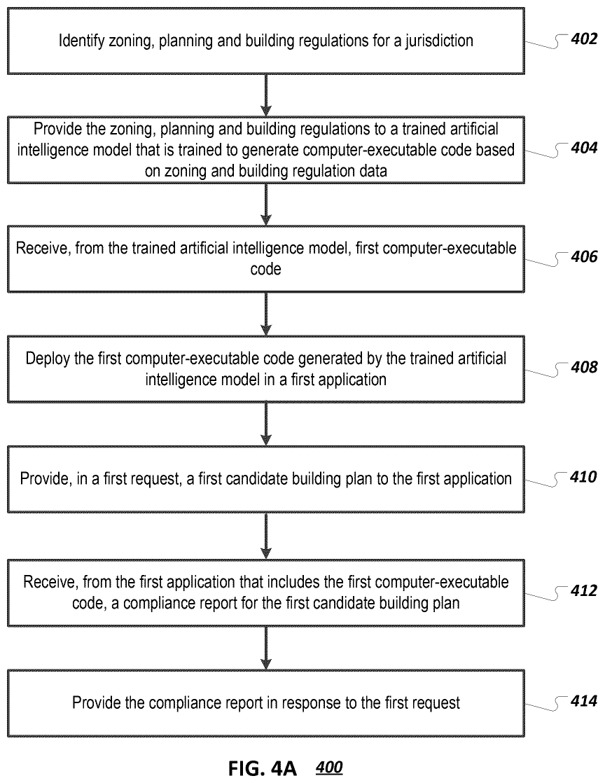

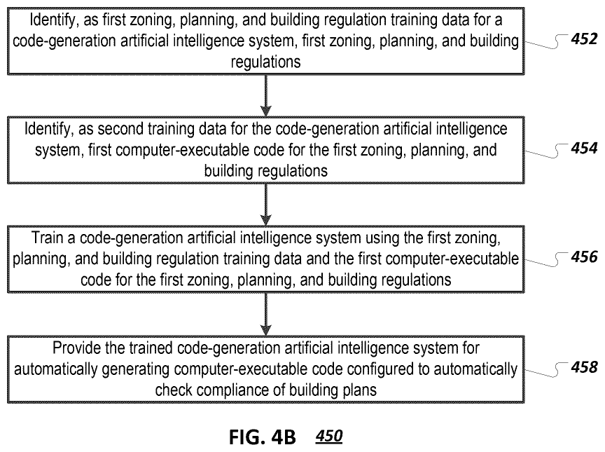

FIG. 4A is a flowchart of an example method 400 for automatically generating computer-executable code for checking zoning and building code compliance.

At 402, zoning, planning, and building regulations for a jurisdiction are received. Other types of regulations relevant for the jurisdiction may also be received.

At 404, the zoning, planning and building regulations are provided to a trained artificial intelligence model that is trained to generate computer-executable code based on zoning, planning, and building regulation data.

At 406, first computer-executable code is received from the trained artificial intelligence model. The first computer-executable code is configured, when executed, to provide output that indicates whether an input candidate building plan complies with the zoning, planning, and building regulations for the jurisdiction.

At 408, the first computer-executable code generated by the trained artificial intelligence model is deployed in a first application.

At 410, a first candidate building plan is provided, in a first request, to the first application that includes the first computer-executable code.

At 412, a compliance report for the first candidate building plan is received from the first application that includes the first computer-executable code. The compliance report includes compliance results for the first candidate building plan with respect to the zoning, planning, and building regulations for the jurisdiction. The compliance report can indicate with which zoning, planning, or building regulations the first candidate building plan is in compliance, out of compliance, or possibly out of compliance. The compliance report can indicate how and which specific conditions in the first candidate building plan were met that led to a given regulation applying to a particular portion of the first candidate building plan. The specific conditions can be presented in a graphical tree representation (e.g., a decision tree).

At 414, the compliance report is provided in response to the first request.

FIG. 4B is a flowchart of an example method 450 for training a code-generation artificial intelligence system to generate computer-executable code for checking zoning, planning, and building code compliance.

At 452, first zoning, planning, and building regulations are identified as first zoning, planning, and building regulation training data for a code-generation artificial intelligence system.

At 454, first computer-executable code for the first zoning, planning, and building regulations is identified as second training data for the code-generation artificial intelligence system. The first computer-executable code is configured, when executed, to provide output that indicates whether an input candidate building plan complies with the first zoning, planning, and building regulations. The first computer-executable code of the second training data can include code written by expert software engineers.

At 456, the code-generation artificial intelligence system is trained using the first zoning, planning, and building regulation training data and the first computer-executable code for the first zoning, planning, and building regulations to automatically generate computer-executable code configured to automatically check compliance of building plans with respect to an inference input set of zoning, planning, and building regulations. The code-generation artificial intelligence system can be further trained using other sets of regulation and corresponding computer-executable code. In some cases, training the code-generation artificial intelligence system can include: prompting the code-generation artificial intelligence system to generate chain of thought reasoning when generating the second computer-executable code; and using the chain of thought reasoning to further train the code-generation artificial intelligence system. The prompting can include zero-shot prompting and/or few-shot prompting.

In some implementations, training can include: prompting, during training, the code-generation artificial intelligence system to generate computer-executable code for the first zoning, planning, and building regulations; receiving second computer-executable code from the code-generation artificial intelligence system in response to the prompting; executing the second computer-executable code using first training building plans to generate first test output; executing the first computer-executable code in the second training data using the first training building plans to generate second test output; generating a comparison of the first test output and the second test output; and providing, as further training data, the comparison of the first test output and the second test output to the code-generation artificial intelligence system.

In some cases, training can include: prompting a first artificial intelligence model to generate synthetically-generated variations of the first computer-executable code and the first zoning, planning, and building regulations; and training the code-generation artificial intelligence system using the synthetically-generated variations of the first computer-executable code and the first zoning, planning, and building regulations. Generating the synthetically-generated variations of the first computer-executable code and the first zoning, planning, and building regulations can include prompting the first artificial intelligence model to perform rephrasing and randomization of the first computer-executable code and the first zoning, planning, and building regulations.

In some cases, training can include reinforcement learning or alignment-based algorithms that use scorer modules to rate the quality and accuracy of the generated code. For example, Direct Preference Optimization, Group Relative Policy Optimization, Reinforcement Learning from Human Feedback, or other reinforcement learning algorithms may be used to train the AI model. This may be done following supervised fine tuning or without supervised fine tuning. These may use automated score functions to score the quality and accuracy of the code. For example, the score functions could be AI-based scores where an AI model is queried to check the accuracy of the number values in the generated code. For example, the score functions could be simple functions to check if all the API calls in the generated code are valid.

At 458, the trained code-generation artificial intelligence system is provided for automatically generating computer-executable code configured to automatically check compliance of building plans.

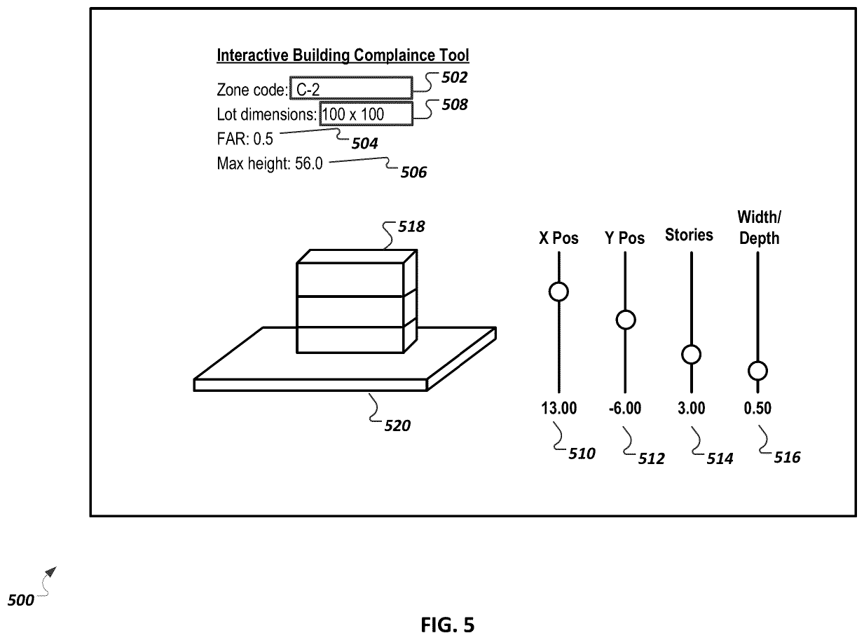

FIG. 5 illustrates an example user interface 500 of an interactive building compliance tool. The building compliance tool can include or use computer-executable code that has been generated by an AI system (e.g., the AI system 106) that can check building plan characteristics for compliance for a given jurisdiction. As another example, the building compliance tool can include or use an AI model that is configured to provide answer responses in response to queries about a set of building and zoning codes.

For instance, the building compliance tool may be configured to check compliance of building plans for zoning (and possible other codes) that are associated with a zone code identifier 502. In some implementations, the user can enter or select a zone code identifier for a particular zone from among a set of zone code identifiers for which the building compliance tool includes corresponding computer-executable code or for which the building compliance tool includes an AI model trained to answer questions about zoning regulations for that zone. The building compliance tool can automatically determine and display a maximum floor-area-ratio (FAR) 504 and a max-height value 506 for the zone corresponding to the zone code identifier 502.

The user interface 500 can enable the user to enter certain values corresponding to a candidate building plan. For instance, the user has entered lot dimensions 508 of 100×100. As another example, the user interface 500 includes slider controls 510, 512, 514, and 516 for configuring candidate values for an X-position on the lot, a Y-position on the lot, a number of stories, and a width-depth ratio of a building, respectively. The building compliance tool can initially display a set of values for the X-position, Y-position, number of stories, and width-depth ratio that collectively satisfy the maximum FAR ratio 504 and the max-height value 506 (and possibly other zoning codes). The building compliance tool can render a corresponding maximum developable ratio representation 518 on a lot representation 520 that corresponds to presently-displayed values.

Upon receiving or detecting a change to a building plan value (e.g., a lot size change or a changed value for one of the slider controls 510, 512, 514, or 516), the building compliance tool can check whether the change to the building plan value would result in a compliant building plan. In some cases, the user interface 500 can prevent a user from sliding a respective slider control 510, 512, 514, or 516 to a value that would result in a non-compliant plan. In some cases, the building compliance tool may allow the user to set such a value but may display an error message if changing a plan value would result in a non-compliant plan.

FIG. 6 illustrates a system 600 for extracting and augmenting structured zoning and building code information. The system 600 can be used to build training and evaluation datasets for an AI system using one or more of LLMs, expert raters, partners, and geospatial data from internal and/or third party sources. The system 600 can be used for extraction of zoning and building code information into a structured queryable form.

The system 600 can receive different types of inputs, such as municipal documents 602, geospatial data 604, search index data 606, and past proposal data 608. The municipal documents 602 can include documents of different formats (e.g., HTML (HyperText Markup Language), PDF (Portable Document Format)) that may be retrieved, for example, from municipal websites or directly from third parties that manage municipal code documents. The geospatial data 604 can include various forms and types of geospatial information that may be obtained from multiple sources, including, for example, municipal zoning maps, site parcel boundaries, retail establishment locations, etc. The search index data 606 can include search engine annotations of website content, such as annotations of municipal documents 602 that were retrieved from municipal websites. The past proposal data 608 can include previously-submitted development proposal documents that were submitted to municipalities, along with records of approvals, rejections, proposal adjustments, etc., and can be stored as proposals and outcome data 609.

A document analysis engine 610 can be used to transform information included in the municipal documents 602 (and possibly other input data) into a relational form more amenable for structured querying. For example, a segmenter 612 can break up received documents into smaller units. For instance, the segmenter 612 can split documents into portions based on section breaks that naturally occur in original documents. In some examples, the segmenter 612 can use heuristics to split longer document sections into multiple shorter sections so that the shorter sections are of roughly equal-sized chunks (e.g., 200-400 words).

In some examples, the segmenter 612 can be, include, or use an LLM for document segmentation. For example, the LLM can have a sufficient context window to receive municipal documents 602 and the LLM can be prompted with instructions to (1) split each document into sections of a given length based on document content; and/or (2) accurately summarize existing document sections. The segmenter 612 may use multiple segmenting approaches and the system 600 can store and use multiple representations of documents. For example, the system 600 may maintain: 1) original documents; 2) split versions of the original documents; 3) LLM-generated document/section summaries; and 4) LLM-generated document segmentations.

After the segmenter 612 has created segmented versions of the municipal documents, the segmented versions (and in some cases the original versions) can be provided to a graph builder 614. The graph builder 614 can create graphs 616 that represent connections between different sections of zoning code. The graph builder 614 can make several passes through documents and use different techniques to identify connections (e.g., by identifying explicit references from one document section to another document section, and by LLM-detected references that lack explicit links/references).

An embedder 618 can be, include, or use one or more large language models (LLM) for creating embeddings 620 that represent content of each segmented/extracted chunk of zoning or building code as a series of numbers in a high-dimensional space. Creation of the embeddings 620 can enable searching for municipal documents in a semantic space.

A parameter extractor 622 can use a series of algorithms and models to extract values of known zoning parameters 624 from zoning code to construct a mapping from specific zones to specific parameter values. For example, in the United States, generally residential zones in cities specify constraints on a maximum building height, a minimum setback from the street, a maximum floor-to-area ratio, etc. The parameter extractor 622 can, for example, scan the text of zoning code and use both traditional NLP (Natural Language Processing) and LLM approaches to parse scanned text to create the zoning parameters 624 as a mapping of zones to parameter values. The parameter extractor 622 can also generate and store, in the zoning parameters 624, confidence values that indicate a degree of confidence of identified parameter values for given zones.

In some implementations, site and building analyzers 626 can also or alternatively identify zone-to-parameter mappings in the zoning parameters 624. In some examples, parameters for zones can be identified in obtained (e.g., purchased or otherwise obtained) parcel-level zoning data that can be searched or queried to identify, for a given address or zone, which zoning parameters are applicable. The site and building analyzers 626 can obtain additional or other zoning parameter information using, for example, computer vision and NLP methods. For example, the geospatial data 604 may include satellite imagery of a neighborhood and the site and building analyzers 626 can extract estimated heights of all buildings and possibly other building metrics in the neighborhood which can be cross-referenced with known zoning code maps to establish likely zoning code restrictions such as maximum building height, even without knowledge of the actual zoning code. For instance, if the tallest of 600 buildings in a residential neighborhood is 30 feet high, the site and building analyzers 626 can determine that anything taller than 30 feet likely violates applicable zoning code.

A question and answer task generation engine 628 can supplement data extracted from various sources with additional information that can be used to improve semantic search and query answering, for example. For instance, the question and answer task generation engine 628 can include and/or use various LLMs to create additional layers of information that provide additional context to zoning and building code information. The additional context can improve, for example, questioning and answering. For instance, different LLM agents can be developed that anticipate the kinds of queries that may arise in diverse use cases and prepare task training data 629 that includes a database of anticipated questions and corresponding answers.

In further detail, a generator 630, which can include one or more LLMs, can be provided with information for a number of predetermined use cases. The predetermined use cases can include, for example, 1) a homeowner is trying to determine whether or not they may build an ADU (Accessory Dwelling Unit); 2) a real estate developer is trying to find a suitable part of town for a town home development, etc. The generator 630 can be prompted to supplement the predetermined use cases with other use cases. Additionally, the generator 630 can be prompted to generate concrete queries that can be evaluated using zoning and building code information maintained by the system 600. The generator 630 can then use LLM agents to generate answers to the questions, which can include multiple answer candidates for each question. Question answer generation is described in more detail below. The generator 630 can continue to generate question and answer pairs 632 until a sufficient number of question and answer pairs (e.g., thousands of question and answer pairs) have been generated.

Once a sufficient number of question and answer pairs are generated, an evaluator 634 can perform an evaluation procedure. For instance, the evaluator 634 can include or use one or more LLMs to iteratively select high quality answers for each question. For example, the evaluator 634 can use LLMs that are fine-tuned on curated subsets of question and answer data by prompting those LLMs to determine accuracy of each candidate answer relevant to a given subset along with a logical chain of reasoning that justifies the accuracy of the answer. The evaluator 634 can use another LLM that acts as a judging LLM that can assess plausibility of the different accuracy evaluations and render a final judgment regarding which candidate answer is a best answer. The best determined answers can be stored in the task training data 629.

The task training data 629, and in some implementations the proposals and outcome data 609, can be used to train LLM model(s) for question and answer processing for compliance. The task training data 629, the proposals and outcome data 609, the graphs 616, the embeddings 620, and zoning parameters 624 can each be included as part of a queryable database 638 queried by trained LLMs, as described below. While the question and answer task generation engine 628, the site and building analyzers 626, and the document analysis engine 610 can perform tasks automatically, human supervision activities 640 can also be performed.

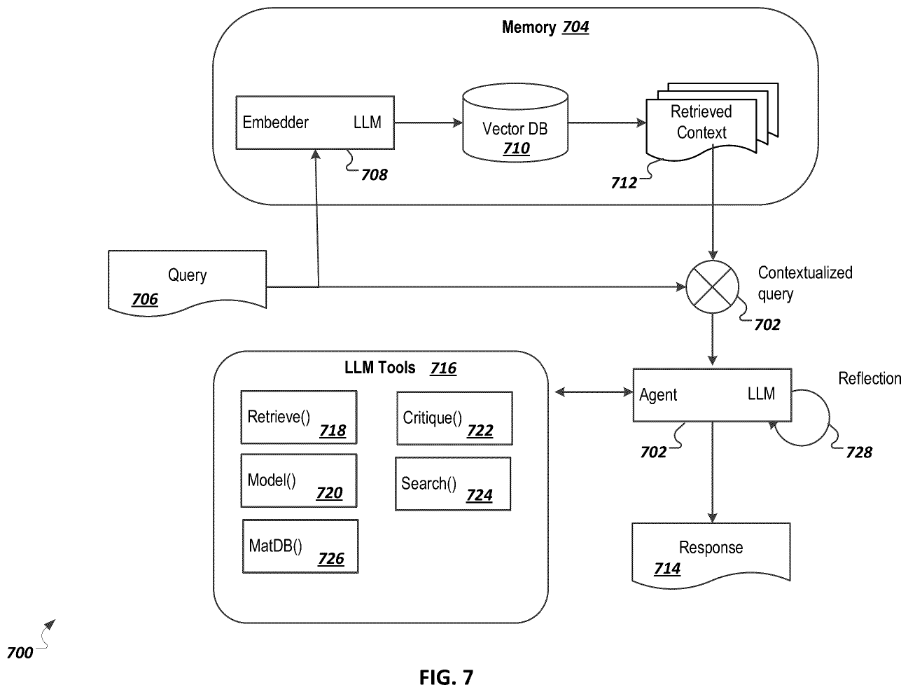

FIG. 7 illustrates an example question and answering system 700 for zoning and building code compliance. The system 700 can be used for automatically answering a range of queries about zoning and building code. The system 700 can use retrieval-augmented generation (RAG) approaches in which an LLM 702 (e.g., an LLM agent, or another model) uses data from a searchable external memory 704.

For example, the system 700 can receive, as input, a query 706. An embedder 708 (which can be a trained LLM different from the LLM 702) can embed the query 706 in a semantic space. The embedder 708 can then perform a search in a vector database 710 to find retrieved context 712 (e.g., sections of zoning or building code) that are highly similar to the query 706. The retrieved context 712 can include a collection of high-scoring candidates and can be returned to an invoking context of the query 706, which can include providing both the query 706 and the retrieved context 712 to the LLM 702 which is asked to generate an answer to the query 706.

The LLM 702 can act autonomously (e.g., largely without human supervision). The LLM 702 can, when generating a response 714 to the query 706, use or invoke various LLM tools 716. The LLM tools 716 can include retrieve 718, model 720, critique 722, search 724, and “MatDB” (e.g., materials database) 726 tools, to name a few examples. The LLM tools 716 can be, for example, LLM routines specifically designed for a context of zoning and building compliance assessment. Some or all of the LLM tools 716 can include custom prompts for the LLM 702, such as prompts designed for retrieval and evaluation accuracy as well as for functionality specific to available resources related to zoning and building compliance assessment.

For example, the MatDB tool 726 can interact with a materials database that includes detailed information on thousands of potential building materials and products. The MatDB tool 726 can interact (or include) a specialized LLM trained to interface with a materials database API (Application Programming Interface), such as for generating structured queries against the materials database that can be used to help resolve questions relevant to the query 706 and generation of the response 714. For instance, in some cases the query 706 might be an inquiry regarding where to obtain pre-fabricated wall panels that meet specifications laid out in a part of an international building code. The query 706 can be translated to relevant zoning parameters and, in turn, the zoning parameters can be converted to constraints or API parameters for materials database API queries, which can be submitted using the MatDB tool 726 with results returned to the user (after possible interpretation and/or reformatting) in the response 714. The LLM 702 can perform reflection operations 728 to reflect on the response 714, to improve responses over time.

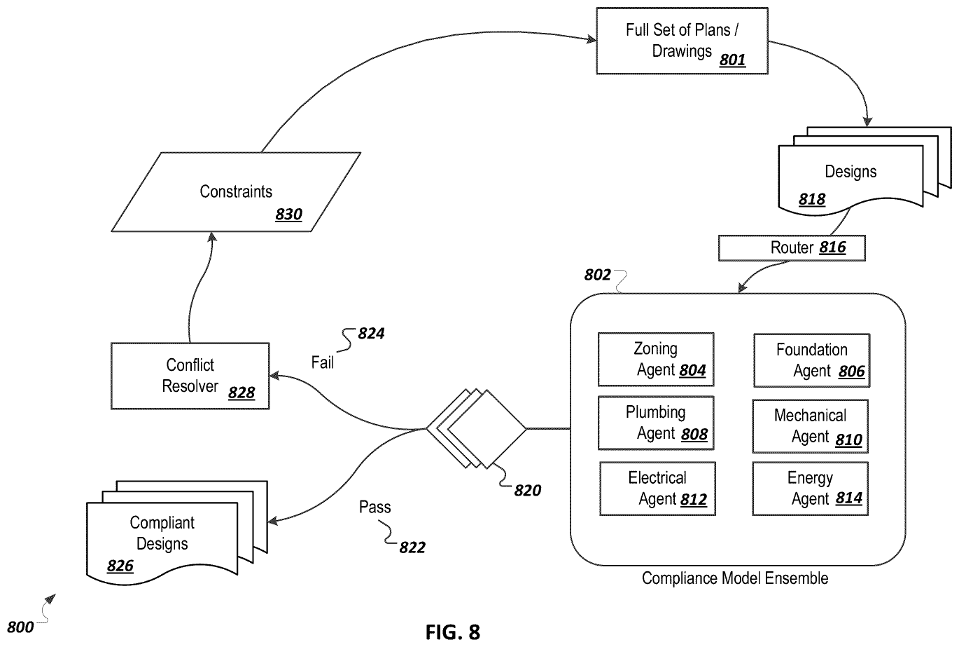

FIG. 8 illustrates an example system 800 for compliance assessment. The system 800 can be used for assessing compliance of proposed designs in an end-to-end context (e.g., given an input of a comprehensive set of architectural and structural drawings 801 for a proposed design). The system 800 can determine whether an entire proposal (e.g., a proposal produced by a generative design engine) complies with relevant zoning and building regulations.

The system 800 includes a model ensemble 802 that includes a collection of individual LLM agent-based compliance models, each specialized for a particular sub-domain of an overall AEC (architecture, engineering, and construction) space. For instance, the model ensemble 802 includes a zoning agent 804 specialized for zoning, a foundation agent 806 specialized for building foundations, a plumbing agent 808 specialized for plumbing, a mechanical agent 810 specialized for mechanical items, an electrical agent 812 specialized for electrical items, and an energy agent 814 specialized for energy items. Other examples are possible. For instance, the model ensemble 802 may include other models for structural design, interior design, etc.

Each model in the model ensemble 802 can have an architecture that generally matches that of the LLM 702 described above with respect to FIG. 7. However, each model in the model ensemble 802 can be trained on a different subset of a zoning and building code database (e.g., the database 638 of FIG. 6). Furthermore, each model in the model ensemble 802 may have or use a different toolkit of available routines. For example, a structural design agent may interface with a physical simulation engine capable of assessing whether or not a design would hold up to real-world weather conditions, whereas an interior design agent would likely not interface with such an engine.

A router 816 can route respective designs 818 included in the set of architectural and structural drawings 801 to appropriate models in the model ensemble 802. In some cases, the router 816 uses a deterministic mapping to determine which model of the model ensemble 802 receives which designs. For instance, some or all of the designs 818 may be labeled, named, or typed in a manner in which a deterministic mapping of a design to a model can be performed. In some examples, the router 816 may be or include a trained multimodal transformer model that is trained to make routing decisions. For example, suppose the set of architectural and structural drawings 801 includes thirty generated CAD (Computer Aided Design) files. The router 816 can use rendering tools to render several static images of each design and then feed those images to a trained multimodal classifier that outputs, for each design, a correct compliance model target indicating which model is appropriate for the design.

Once a given design is appropriately routed to a compliance model in the model ensemble 802, the model is prompted with instructions to assess the compliance of the design. Each model that is prompted can generate a structured compliance model output 820 which can include a result indicating a pass status 822 or a fail status 824, as well as both structured and free-text descriptions of any design elements that prevent compliance. In the event that all compliance models provide a positive answer of the pass status 822, the overall design can be considered compliant (and respective compliant designs 826 can be marked as such, along with a marking of the set of architectural and structural drawings 801 as compliant and/or a response to a submission of the set of architectural and structural drawings 801 for compliance evaluation being marked as successful/compliant).

If at least one model of the model ensemble 802 produces the fail status 824, a conflict resolution process can be performed by a conflict resolver 828. The conflict resolver 828 can take as input all of the outputs from the individual compliance models of the model ensemble 802. The conflict resolver 828 can be a multimodal transformer trained to resolve compliance failures that might involve multiple competing constraints. For designs that are non-compliant, the conflict resolver 828 can identify new design constraints 830 that, if incorporated into the set of architectural and structural drawings 801, would likely lead to compliance. The new design constraints 830 can be provided to a generative design engine that created the set of architectural and structural drawings 801, to enable the generative design engine to create a new set of designs that incorporate the new design constraints 830. The new set of designs can be evaluated using models of the model ensemble 802, as described above.

In some examples, the system 800 can include a user interface that enables human input into the resolution process via a natural language interface. For example, the conflict resolver 828 can receive free-text instructions from an expert who has inspected the compliance model outputs 820. The expert input can provide contextual information that can be used by the conflict resolver 828 to resolve what may be otherwise impossible cases (e.g., situations where there is simply no way to satisfy all constraints simultaneously). For example, suppose the designs 818 include specification(s) of a net carbon-negative design and also building in an area with high seismic activity resulting in building code requirements that are expensive to meet using sustainable materials (and thus making net carbon negative not generally possible). Expert input can provide guidance as to which of the competing design choices may be less important and therefore which of the new design constraints 830 can prioritize which design changes to move designs into compliance.

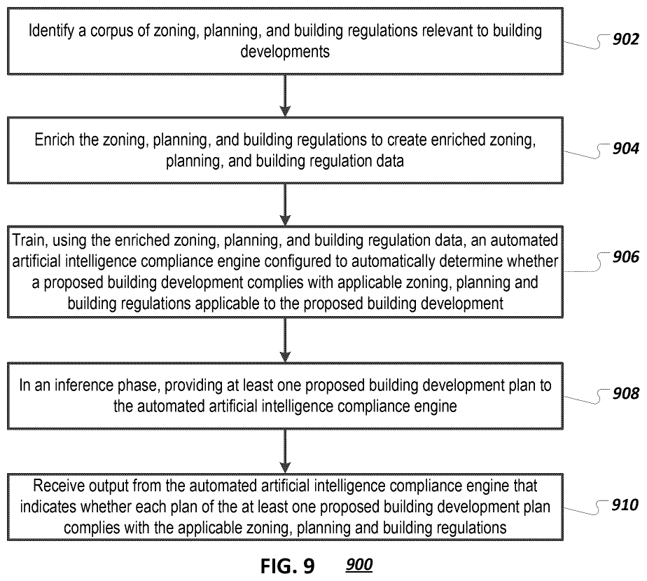

FIG. 9 is a flowchart of an example method 900 for automated zoning compliance.

At 902, a corpus of zoning, planning, and building regulations relevant to building developments is identified. The corpus of zoning, planning, and building regulations can include municipal documents, geospatial data, search index data, and past proposal data and proposal outcomes.

At 904, the zoning, planning, and building regulations are enriched to create enriched zoning, planning, and building regulation data. Creating the enriched zoning, planning, and building regulation data can include: identifying, in first regulation data, a reference to second regulation data; obtaining the second regulation data; and replacing, in the first regulation data, the reference to the second regulation data with the second regulation data. As another example, creating the enriched zoning, planning, and building regulation data can include: identifying, in first regulation data, at least one table or figure; converting the at least one table or figure to converted text; and replacing the at least one table or figure with the converted text. In some examples, creating the enriched zoning, planning, and building regulation data can include converting a first regulation document into at least one smaller document version. Converting the first regulation document into at least one smaller document version can include splitting the first regulation document into multiple smaller documents or using a large language model to create a summary of the first regulation document. In some implementations, creating the enriched zoning, planning, and building regulation data can comprise including, in the enriched zoning, planning, and building regulation data, multiple of the first regulation document, the multiple smaller documents, and the summary of the first regulation document.

In some examples, creating the enriched zoning, planning, and building regulation data includes creating a graph that represents explicit or implicit connections between different documents or sections of zoning, planning, and building regulations. Creating the enriched zoning, planning, and building regulation data can include, in some implementations, creating embeddings of identified zoning, planning, and building regulations. In some cases, creating the enriched zoning, planning, and building regulation data includes using a question generator artificial intelligence engine to enrich the zoning, planning, and building regulation data with question and answer pairings for questions that may be asked regarding the zoning, planning, and building regulation data.

At 906, an automated artificial intelligence compliance engine is created using the enriched zoning, planning, and building regulation data. The automated artificial intelligence compliance engine is configured to automatically determine whether a proposed building development complies with applicable zoning, planning, and building regulations applicable to the proposed building development. The automated artificial intelligence compliance engine can be a trained large language model. The automated artificial intelligence compliance engine can be trained using expert-curated training data and synthetic training data.

In some implementations, the automated artificial intelligence compliance engine includes different compliance agents for different types of compliance, such as a zoning agent, a foundation agent, a plumbing agent, a mechanical agent, an electrical agent, and an energy agent. The automated artificial intelligence compliance engine can include a routing engine that is configured to identify different portions of a proposed building development plan that are applicable to different compliance agents and route the different portions to the different compliance agents. Each compliance agent can be configured to provide information regarding compliance for a corresponding type of compliance.

At 908, in an inference phase, at least one proposed building development plan is provided to the automated artificial intelligence compliance engine.

At 910, output is received from the automated artificial intelligence compliance engine that indicates whether each plan of the at least one proposed building development plan complies with the applicable zoning, planning, and building regulations. The output can identify, for a given proposed building development plan, with which regulations the proposed building development plan is in compliance, with which regulations the proposed building development plan is not in compliance, and with which regulations the proposed building development plan might not be in compliance. The output can be provided to the automated artificial intelligence building development plan engine as feedback for the automated artificial intelligence building development plan engine.

In examples where the output indicates that at least one design of the first proposed building development plan does not comply with applicable zoning, planning, and building regulations, a conflict resolver can determine new constraints for the at least one design that, if incorporated into the first proposed building development plan, would likely result in the at least one design being in compliance with the applicable zoning, planning, and building regulations. The new constraints can be included in the output provided to the automated artificial intelligence building development plan engine.

### Other Implementations

A first implementation is described below in the claims. Other implementations may be provided. For instance, a second implementation may include the following examples.
Example 1. A computer-implemented method comprising: identifying, as first zoning, planning, and building regulation training data for a code-generation artificial intelligence system, first zoning, planning, and building regulations; identifying, as second training data for the code-generation artificial intelligence system, first computer-executable code for the first zoning, planning, and building regulations that is configured, when executed, to provide output that indicates whether an input candidate building plan complies with the first zoning, planning, and building regulations; training, as a trained code-generation artificial intelligence system, the code-generation artificial intelligence system using the first zoning, planning, and building regulation training data and the first computer-executable code for the first zoning, planning, and building regulations to automatically generate computer-executable code configured to automatically check compliance of building plans with respect to an inference input set of zoning, planning, and building regulations; and providing the trained code-generation artificial intelligence system for automatically generating computer-executable code configured to automatically check compliance of building plans.
Example 2. The computer-implemented method of Example 1, further comprising further training the trained code-generation artificial intelligence system using second zoning, planning, and building regulation training data and second computer-executable code that is configured, when executed, to provide output that indicates whether an input candidate building plan complies with the second zoning, planning, and building regulations.
Example 3. The computer-implemented method of Example 1, wherein training the code-generation artificial intelligence system comprises: prompting, during training, the code-generation artificial intelligence system to generate computer-executable code for the first zoning, planning, and building regulations; receiving second computer-executable code from the code-generation artificial intelligence system in response to the prompting; executing the second computer-executable code using first training building plans to generate first test output; executing the first computer-executable code in the second training data using the first training building plans to generate second test output; generating a comparison of the first test output and the second test output; and providing, as further training data, the comparison of the first test output and the second test output to the code-generation artificial intelligence system.
Example 4. The computer-implemented method of Example 3, wherein training the code-generation artificial intelligence system comprises: prompting the code-generation artificial intelligence system to generate chain of thought reasoning when generating the second computer-executable code; and using the chain of thought reasoning to further train the code-generation artificial intelligence system.
Example 5. The method of Example 3, wherein training the code generation artificial intelligence system comprises an alignment or reinforcement learning step in which automated scoring functions are used to improve output code quality according to the scoring functions.
Example 6. The computer-implemented method of Example 3, wherein the prompting comprises zero-shot prompting.
Example 7. The computer-implemented method of Example 3, wherein the prompting comprises few-shot prompting.
Example 8. The computer-implemented method of Example 1, wherein the first computer-executable code of the second training data includes code written by expert software engineers.
Example 9. The computer-implemented method of Example 1, further comprising: prompting a first artificial intelligence model to generate synthetically-generated variations of the first computer-executable code and the first zoning, planning, and building regulations; and training the code-generation artificial intelligence system using the synthetically-generated variations of the first computer-executable code and the first zoning, planning, and building regulations.
Example 10. The computer-implemented method of Example 9, wherein generating the synthetically-generated variations of the first computer-executable code and the first zoning, planning, and building regulations comprises prompting the first artificial intelligence model to perform rephrasing and randomization of the first computer-executable code and the first zoning, planning, and building regulations.

A third implementation may include the following examples.
Example 1. A computer-implemented method comprising: identifying a corpus of zoning, planning, and building regulations relevant to building developments; enriching the zoning, planning, and building regulations to create enriched zoning, planning, and building regulation data; creating, using the enriched zoning, planning, and building regulation data, an automated artificial intelligence compliance engine configured to automatically determine whether a proposed building development complies with applicable zoning, planning, and building regulations applicable to the proposed building development; in an inference phase, providing at least one proposed building development plan to the automated artificial intelligence compliance engine; and receiving output from the automated artificial intelligence compliance engine that indicates whether each plan of the at least one proposed building development plan complies with the applicable zoning, planning, and building regulations.
Example 2. The computer-implemented method of Example 1, wherein the corpus of zoning, planning, and building regulations comprises municipal documents, geospatial data, search index data, and past proposal data and proposal outcomes.
Example 3. The computer-implemented method of Example 1, wherein creating the enriched zoning, planning, and building regulation data comprises: identifying, in first regulation data, a reference to second regulation data; obtaining the second regulation data; and replacing, in the first regulation data, the reference to the second regulation data with the second regulation data.
Example 4. The computer-implemented method of Example 1, wherein creating the enriched zoning, planning, and building regulation data comprises: identifying, in first regulation data, at least one table or figure; converting the at least one table or figure to converted text; and replacing the at least one table or figure with the converted text.
Example 5. The computer-implemented method of Example 1, wherein creating the enriched zoning, planning, and building regulation data comprises converting a first regulation document into at least one smaller document version.
Example 6. The computer-implemented method of Example 5, wherein converting the first regulation document into at least one smaller document version comprises splitting the first regulation document into multiple smaller documents or using a large language model to create a summary of the first regulation document.
Example 7. The computer-implemented method of Example 6, wherein creating the enriched zoning, planning, and building regulation data comprises including, in the enriched zoning, planning, and building regulation data, multiple of the first regulation document, the multiple smaller documents, and the summary of the first regulation document.
Example 8. The computer-implemented method of Example 1, wherein creating the enriched zoning, planning, and building regulation data comprises creating a graph that represents explicit or implicit connections between different documents or sections of zoning, planning, and building regulations.
Example 9. The computer-implemented method of Example 1, wherein creating the enriched zoning, planning, and building regulation data comprises creating embeddings of identified zoning, planning, and building regulations.
Example 10. The computer-implemented method of Example 1, wherein creating the enriched zoning, planning, and building regulation data comprises using a question generator artificial intelligence engine to enrich the zoning, planning, and building regulation data with question and answer pairings for questions that may be asked regarding the zoning, planning, and building regulation data.
Example 11. The computer-implemented method of Example 1, wherein the automated artificial intelligence compliance engine is a trained large language model.
Example 12. The computer-implemented method of Example 1, wherein the automated artificial intelligence compliance engine is trained using expert-curated training data and synthetic training data.
Example 13. The computer-implemented method of Example 1, wherein a set of proposed building development plans are provided to the automated artificial intelligence compliance engine and receiving output comprises receiving output that indicates which proposed building development plans in the set of proposed building development plans are in compliance with the applicable zoning, planning, and building regulations.
Example 14. The computer-implemented method of Example 1, wherein the output identifies, for a given proposed building development plan, with which regulations the proposed building development plan is in compliance, with which regulations the proposed building development plan is not in compliance, and with which regulations the proposed building development plan might not be in compliance.
Example 15. The computer-implemented method of Example 1, wherein the automated artificial intelligence compliance engine includes different compliance agents for different types of compliance, wherein the different compliance agents include a zoning agent, a foundation agent, a plumbing agent, a mechanical agent, an electrical agent, and an energy agent.
Example 16. The computer-implemented method of Example 15, wherein: the automated artificial intelligence compliance engine includes a routing engine that is configured to identify different portions of a proposed building development plan that are applicable to different compliance agents and route the different portions to the different compliance agents; and each compliance agent is configured to provide information regarding compliance for a corresponding type of compliance.
Example 17. The computer-implemented method of Example 15, wherein: a first proposed building development plan is generated by an automated artificial intelligence building development plan engine and provided to the automated artificial intelligence compliance engine; the output indicates whether the first proposed building development plan complies with the applicable zoning, planning, and building regulations; and the output is provided to the automated artificial intelligence building development plan engine as feedback for the automated artificial intelligence building development plan engine.
Example 18. The computer-implemented method of Example 17, wherein the output indicates that at least one design of the first proposed building development plan does not comply with applicable zoning, planning, and building regulations, the method further comprising: determining, by a conflict resolver, new constraints for the at least one design that, if incorporated into the first proposed building development plan, would likely result in the at least one design being in compliance with the applicable zoning, planning, and building regulations; and including the new constraints in the output provided to the automated artificial intelligence building development plan engine.
Example 19. The computer-implemented method of Example 1, further comprising: receiving a query related to the zoning, planning, and building regulations; enriching the query with additional context from the enriched zoning, planning, and building regulations; providing an enriched query to the automated artificial intelligence compliance engine; receiving a query answer from the automated artificial intelligence compliance engine; and providing the query answer in response to the query.

Implementations of the subject matter and the functional operations described in this specification can be implemented in digital electronic circuitry, in tangibly-implemented computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including, by way of example, a programmable processor, a computer, or multiple processors or computers. The apparatus can also be or further include special purpose logic circuitry, e.g., a central processing unit (CPU), an FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, and can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of sub-combinations.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be helpful. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method comprising:
identifying, as first training data for an artificial intelligence model, different sets of training zoning, planning, and building regulations;
identifying, as second training data for the artificial intelligence model, different sets of training computer-executable code for the different sets of training zoning, planning, and building regulations, wherein each set of training computer-executable code is configured, when executed, to provide output that indicates whether an input candidate building plan complies with a respective set of training zoning, planning, and building regulations;
training, as a trained artificial intelligence model, the artificial intelligence model using the different sets of training zoning, planning, and building regulations and the different sets of training computer-executable code for the different sets of training zoning, planning, and building regulations to automatically generate computer-executable code configured to automatically check compliance of building plans with respect to model input zoning, planning, and building regulations;
identifying first model input zoning, planning, and building regulations relevant for building development for a jurisdiction, wherein the first model input zoning, planning, and building regulations are not included in the first training data;
providing the first model input zoning, planning, and building regulations to the trained artificial intelligence model that is trained to generate computer-executable code with respect to model input zoning, planning, and building regulations;
receiving, from the trained artificial intelligence model, first computer-executable code that is different from the different sets of training computer-executable code and is configured, when executed, to provide output that indicates whether an input candidate building plan complies with the first model input zoning, planning, and building regulations for the jurisdiction;
deploying the first computer-executable code generated by the trained artificial intelligence model in a first application;
providing, in a first request, a first candidate building plan to the first application that includes the first computer-executable code;
receiving, from the first application that includes the first computer-executable code, a compliance report for the first candidate building plan that includes compliance results for the first candidate building plan with respect to the first model input zoning, planning, and building regulations for the jurisdiction; and
providing the compliance report in response to the first request.

2. The computer-implemented method of claim 1, further comprising:
creating enriched zoning, planning, and building regulations by enriching the first model input zoning, planning, and building regulations with additional data; and
providing the enriched zoning, planning, and building regulations to the trained artificial intelligence model.

3. The computer-implemented method of claim 1, wherein enriching includes translating table cell content for a first cell included in the first model input zoning, planning, and building regulations into a sentence form that includes column and row header information corresponding to the first cell.

4. The computer-implemented method of claim 1, wherein enriching includes replacing a first content reference in the first model input zoning, planning, and building regulations with regulation content referenced by the first content reference.

5. The computer-implemented method of claim 1, wherein the trained artificial intelligence model generates the first executable code by performing multiple translation steps.

6. The computer-implemented method of claim 1, wherein output from a first translation step comprises intermediate computer-executable code.

7. The computer-implemented method of claim 6, wherein the intermediate computer-executable code is provided as input to a second translation step that includes adjusting the intermediate computer-executable code.

8. The computer-implemented method of claim 6, wherein adjusting the intermediate computer-executable code includes adding logging code, adding error-handling code, or adjusting portions of the intermediate computer-executable code.

9. The computer-implemented method of claim 1, further comprising validating the first executable code by providing the first executable code to a set of one or more AI-based or rule-based scoring functions that score the compliance checking code for executability, performance, correct syntax, and consistency with original regulatory text.

10. The computer-implemented method of claim 1, wherein the compliance report indicates, for the first candidate building plan, with which regulations the first candidate building plan is in compliance, with which regulations the first candidate building plan is not in compliance, and with which regulations the first candidate building plan might not be in compliance.

11. The computer-implemented method of claim 1, wherein providing the first candidate building plan to the trained artificial intelligence model comprises:
generating a vector representation of the first candidate building plan; and
providing the vector representation of the first candidate building plan to the trained artificial intelligence model.

12. The computer-implemented method of claim 1, wherein the compliance report indicates how and which specific conditions in the first candidate building plan were met that led to a given regulation applying to a particular portion of the first candidate building plan.

13. The computer-implemented method of claim 12, wherein the specific conditions are presented in a graphical tree representation.

14. The computer-implemented method of claim 1, further comprising:
performing geospatial analysis for the first candidate building plan;
determining that certain conditions in the zoning, planning, and building regulations are met based on the geospatial analysis; and
determining with which zoning, planning, or building regulations the first candidate building plan is in compliance based on determining that the certain conditions are met.

15. The computer-implemented method of claim 1, wherein providing the compliance report comprises providing information from the compliance report to a trained artificial intelligence design system trained to generate building designs for a building project.

16. The computer-implemented method of claim 15, wherein the information from the compliance report comprises constraints on specifications for the building project determined from the first model input zoning, planning, and building regulations that are used by the trained artificial intelligence design system to generate building designs that comply with the constraints on the specifications for the building project.

17. A system comprising one or more computers and one or more storage devices on which are stored instructions that are operable, when executed by the one or more computers, to cause the one or more computers to perform operations comprising:
identifying, as first training data for an artificial intelligence model, different sets of training zoning, planning, and building regulations;
identifying, as second training data for the artificial intelligence model, different sets of training computer-executable code for the different sets of training zoning, planning, and building regulations, wherein each set of training computer-executable code is configured, when executed, to provide output that indicates whether an input candidate building plan complies with a respective set of training zoning, planning, and building regulations;
training, as a trained artificial intelligence model, the artificial intelligence model using the different sets of training zoning, planning, and building regulations and the different sets of training computer-executable code for the different sets of training zoning, planning, and building regulations to automatically generate computer-executable code configured to automatically check compliance of building plans with respect to model input zoning, planning, and building regulations;
identifying first model input zoning, planning, and building regulations relevant for building development for a jurisdiction, wherein the first model input zoning, planning, and building regulations are not included in the first training data;
providing the first model input zoning, planning, and building regulations to the trained artificial intelligence model that is trained to generate computer-executable code with respect to model input zoning, planning, and building regulations;
receiving, from the trained artificial intelligence model, first computer-executable code that is different from the different sets of training computer-executable code and is configured, when executed, to provide output that indicates whether an input candidate building plan complies with the first model input zoning, planning, and building regulations for the jurisdiction;
deploying the first computer-executable code generated by the trained artificial intelligence model in a first application;
providing, in a first request, a first candidate building plan to the first application that includes the first computer-executable code;
receiving, from the first application that includes the first computer-executable code, a compliance report for the first candidate building plan that includes compliance results for the first candidate building plan with respect to the first model input zoning, planning, and building regulations for the jurisdiction; and
providing the compliance report in response to the first request.

18. The system of claim 17, wherein the operations further comprise:
creating enriched zoning, planning, and building regulations by enriching the first model input zoning, planning, and building regulations with additional data; and
providing the enriched zoning, planning, and building regulations to the trained artificial intelligence model.

19. One or more computer-readable storage media encoded with instructions that, when executed by one or more computers, cause the one or more computers to perform operations comprising:
identifying, as first training data for an artificial intelligence model, different sets of training zoning, planning, and building regulations;
identifying, as second training data for the artificial intelligence model, different sets of training computer-executable code for the different sets of training zoning, planning, and building regulations, wherein each set of training computer-executable code is configured, when executed, to provide output that indicates whether an input candidate building plan complies with a respective set of training zoning, planning, and building regulations;
training, as a trained artificial intelligence model, the artificial intelligence model using the different sets of training zoning, planning, and building regulations and the different sets of training computer-executable code for the different sets of training zoning, planning, and building regulations to automatically generate computer-executable code configured to automatically check compliance of building plans with respect to model input zoning, planning, and building regulations;
identifying first model input zoning, planning, and building regulations relevant for building development for a jurisdiction, wherein the first model input zoning, planning, and building regulations are not included in the first training data;
providing the first model input zoning, planning, and building regulations to the trained artificial intelligence model that is trained to generate computer-executable code based on zoning, planning, and building regulation data;
receiving, from the trained artificial intelligence model, first computer-executable code that is different from the different sets of training computer-executable code and is configured, when executed, to provide output that indicates whether an input candidate building plan complies with the first model input zoning, planning, and building regulations for the jurisdiction;
deploying the first computer-executable code generated by the trained artificial intelligence model in a first application;
providing, in a first request, a first candidate building plan to the first application that includes the first computer-executable code;
receiving, from the first application that includes the first computer-executable code, a compliance report for the first candidate building plan that includes compliance results for the first candidate building plan with respect to the first model input zoning, planning, and building regulations for the jurisdiction; and
providing the compliance report in response to the first request.

20. The computer-readable storage media of claim 19, wherein the operations further comprise:
creating enriched zoning, planning, and building regulations by enriching the first model input zoning, planning, and building regulations with additional data; and
providing the enriched zoning, planning, and building regulations to the trained artificial intelligence model.
